(19) United States
(12) Patent Application Publication
(10) Pub. No.: US 2013/0160182 A1
(43) Pub. Date: Jun. 27, 2013

(54) FRONT AND BACK RIGHT AND LEFT RUNNERS SHOULDER LINKING HARNESS

(71) Applicant: Emmanuel Petit-Frere, West Palm Beach, FL (US)

(72) Inventor: Emmanuel Petit-Frere, West Palm Beach, FL (US)

(21) Appl. No.: 13/335,791

(22) Filed: Dec. 22, 2011

(51) Int. Cl. A62B 35/00

(52) U.S. Cl. 2/69

(57) ABSTRACT

A shoulder harness that has four D-rings. Two in the front of shoulder harness at shoulder length and height And two on the back at shoulder length and height.

### BACKGROUND OF THE INVENTION

The invention relates to chest and shoulder harnesses. Specifically to harnesses used by runners.

Chest and shoulder harnesses are used fur a variety of recreation and commercial reasons. Recreational uses include rock climbing and resistance training, while commercial reasons may include emergency service rescues and construction work. There are a variety of chest and shoulder harnesses that exist. Some harnesses are for carrying equipment and others are for training athletes.

### SUMMARY OF THE INVENTION

The shoulder harness includes four D-rings. Two in the front of shoulder harness at shoulder length and height and two in the back at shoulder length and height.

An object of the invention is to allow multiple runners to link to each other shoulder to shoulder from front to back using any type of strap, rope or the like.

The object of the invention will become more fully apparent as the description which follows is read in conjunction with the drawings

### BRIEF DESCRIPTION OF THE DRAWINGS

FIG. 1 is front of linking shoulder harness with D-rings on right and left shoulder. 20A and 20B

FIG. 2 is back of linking shoulder harness with D-rings on right and left shoulder. 20C and 20D

FIG. 3 shows Linking shoulder harness as it would be used.

### DETAILED DESCRIPTION

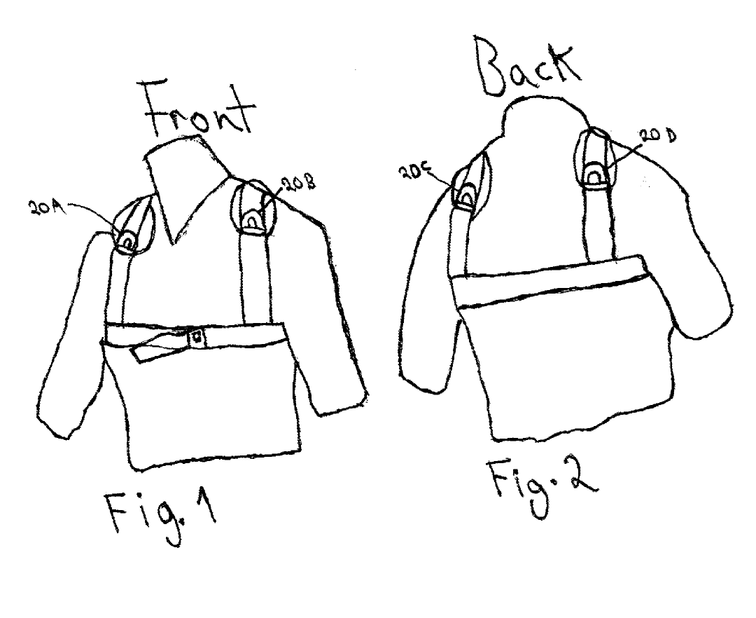

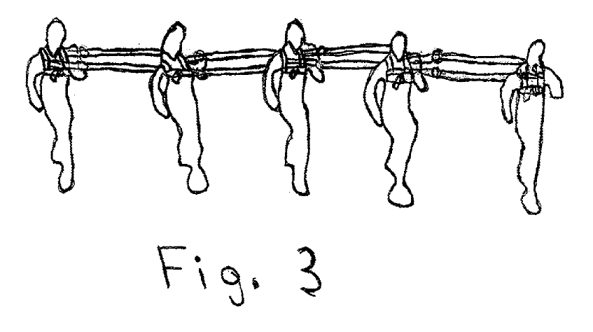

Turning now to the drawing, and initially to FIGS. 1 (front view) and 2 (back view). A shoulder harness constructed according to a preferred embodiment of the invention is depicted on an outline of a human form. There are two D-rings on the front 20A 20B which are at shoulder height and shoulder length. There are two D-rings on the back 20C 20D which are at shoulder height and shoulder length. The D-rings are there to allow runners to link to each other using a strap, rope, cord, or the like FIG. 3.

I claim:

1. A shoulder harness comprising:
Four rings that allow runners, walkers, and joggers to link to each other shoulder to shoulder. Two in the front at shoulder height and length and two in the back at shoulder height and length.
